(19) United States
(12) Patent Application Publication
(10) Pub. No.: US 2020/0270458 A1
(43) Pub. Date: Aug. 27, 2020

(54) BIODEGRADABLE PLOYCERAMICS

(71) Applicant: Mariola Espinosa Bowen, Astoria, NY (US)

(72) Inventor: Mariola Espinosa Bowen, Astoria, NY (US)

(21) Appl. No.: 16/281,233

(22) Filed: Feb. 21, 2019

(51) Int. Cl. C08L 99/00; C08L 3/02; C08L 5/12; C08L 5/06; C08L 1/28; C08L 91/06; C08L 89/06; C08K 5/092

(52) U.S. Cl. CPC C08L 99/00; C08L 3/02; C08L 5/12; C08L 5/06; C08L 2201/06; C08L 91/06; C08L 89/06; C08K 5/092; C08L 1/286

(57) ABSTRACT

The present invention relates to a biodegradable poly-ceramic based on biodegradable formulations for the manufacture of disposable containers of accelerated degradation. These containers have high hardness, high resistance to heat and temperature. Poly-ceramic biodegradable materials are useful for the elaboration of disposable products destined to contain solid food or biological residues of degradation, as well as cold or hot liquids, utensils destined to be discarded or disintegrated as natural nutrients since they are friendly to the environment.

### BACKGROUND

Nowadays, large quantities of disposable plastic containers and polyethylene foams are produced. According to MAIZAR1: ¹MAIZAR. “Neuevos usos para el maíz: Los Plásticos Biodegradables”/Fecha: Nov. 5, 2006. http://www.maizar.org.ar/vertext.php?id=142 Translation—:Maizar. “Novel uses for the corn: The Biodegradable Plastics”/Date: Nov. 5, 2006. Http://www.maizar.org.ar/vertext.php?id=142

Almost everything we buy, most of the food we eat and many of the drinks we drink are packaged in plastic. These containers protect the product, are cheap and seem to last indefinitely. However, its durability is a serious problem for the environment. In addition, traditional plastics are manufactured from petroleum derivatives, which are non-renewable sources of energy.

Seeking a solution to these problems, scientists and engineers have been developing biodegradable plastics obtained from renewable sources, such as plants. A material is biodegradable when it can be degraded to simpler substances by the action of living organisms, and in this way be eliminated from the environment. The reason why traditional plastics are not biodegradable is because they are too long and compact polymers to be attacked and degraded by decomposing organisms. But plastics based on plant polymers have a structure that can be destroyed by microorganisms. Another problem of plastic is that its degradation potentiates the greenhouse effect2: ²Héctor Rodríguez. La degradación del plástico potencia el efecto invernadero. 31 de agosto de 2018 https://www.nationalgeographic.com.es/ciencia/actualldad/degradacion—plastico—potencia—efecto—omvermaderp_13126 Translation: Héctor Rodríguez. The degradation of he plastic greenhouse power. 31 of 2018. Https://www.nationalgeographic.com.es/ciencia/actualidad/degradacion—plastico—potencia—efecto—invernadero_13126

In addition to the effects of accumulation in ecosystems, when degraded, plastics are an important source of greenhouse gases. The accumulation of massive amounts of plastic in ecosystems is one of the major environmental problems that we face today. The plastic embodies a serious threat to biodiversity and to all kinds of fauna: on a large scale we can find it in almost any part of the planet, contaminating places of the most inaccessible; on a small scale, we know that it can even become part of organisms by bioaccumulation.

It is known that plastic bags can take up to 1000 years to degrade, which shows that the problem of solving and trying to find natural substitutes that allow the use of plastic materials and favoring the use of disposable biodegradable materials which are friendly with the environment.

It is known that in the state of the art there are several research works to find a suitable biodegradable formulation. For example, in the patent CN107619504 WUHU CHUANGYUAN NEW MAT CO LTD (Jan. 23, 2018), a film of starch is revealed with cellulose from rice straw grafted with caprolactone. First, the preparation method pulverizes the rice straw to obtain cellulose, steam explosion, extraction with hot water and dissolution of alcohol. Secondly, acetylated rice straw cellulose is prepared. Then the caprolactone is grafted onto the acetylated rice cellulose straw to obtain cellulose grafted with caprolactone. Finally, the corn starch, the cellulose grafted with caprolactone and the polycaprolactone are mixed and gelatinized, cross-linked and flowed. The film is spread to obtain a cellulose film reinforced with rice straw grafted with caprolactone. As it is observed, this formula contains rice fiber since, in the process, rice straw is sprayed, that is, it is a fiber. The only similarity with the present invention is that it comes from the rice plant, but does not contain the same ingredients or perform the same procedure of the invention.

The patent CN107254095 of the company HEFEI DAZHUO ELECTRIC POWER CO., LTD. (Oct. 17, 2017) reveals a material compatible with the environment with high mechanical strength, containing 10-24 parts of polyethylene resin, 17-23 parts of modified wheat starch, 1-9 parts of straw fiber of corn, 4-5 parts of epoxidized soybean oil, 1-3 parts of rice husk powder, 3-8 parts of bamboo powder, 3-9 parts of inorganic filler, 1.3-3.2 parts of bactericide and 1-3 parts of coupling agent. The formula of the environmentally compatible material is adjusted based on the formula of the traditional disposable foamed plastic, the consumption of polyvinyl alcohol can be decreased, and the modified wheat starch, the corn stem fibers, the seed oil Epoxy soya, paddy rice shell powder, bamboo powder, inorganic fillers are increased bactericidal ingredients and coupling agents. The material has a biodegradation rate of 90 days.

The patent EP2380915 of the company BIOP BIOPOLYMER TECHNOLOGIES AG (Oct. 26, 2011) describes a thermoplastic reinforcing material resistant to water and a method for its production. The thermoplastic starch material is obtained by extrusion of natural starch in the presence of 30-60% by weight of the destructuring agent of polyfunctional alcohols selected from ethylene glycol, propylene glycol, glycerol, 1,3-butanediol and diglyceride, corresponding ethers and/or compounds selected from dimethylsulfoxide, dimethylformamide, dimethylurea and dimethylacetamide. The destructuring is carried out in a twin screw extruder at 65-120° C., followed by storage for retrogradation.

These documents disclose a formula based on starch to produce the shape of a gel, contrary to the invention, which does not use starches as the raw material of the biodegradable disposable support material. The article by the author Javier Jimenez (Apr. 4, 2018) points out that plastics would be the best invention in the world if it were not for a very small detail: they are destroying the world; however, we can not live without them.

Therefore, the search for a substitute for commercial plastics is among the priorities of researchers, governments and industry. With little success, yes. Now a team of chemists from the Colorado State University has just presented a polymer that opens the door to the creation of sustainable “plastic materials” and free of waste.

Polymers are a broad class of materials characterized by long chains of chemically linked repeating molecular units called monomers. Plastics, but also fibers, ceramics or rubbers, are polymers. As Eugene Chen, professor at the Department of Chemistry of the CSU, says, “it would be our dream to see a chemically recyclable polymer materialize on the market

A dream that is on its way to becoming reality. Chen and his team have been working on this substitute for years. In 2015, they already presented a polymer with characteristics very similar to commercial plastics, but that only worked in extremely cold conditions. I was unable to use it in everyday life.

Now, however, they have given the bell. They have discovered that polymer, one that the researchers explain has many of the same characteristics that we enjoy in plastics (light weight, heat resistance, durability, etc.) and, in addition, a complete chemical recyclability. To which, if that were not enough, can be achieved without the use of toxic chemicals or complex laboratory procedures.

The numerous data they present make their claim that the new structure solves the problems of the previous polymers very plausible and the monomer can be polymerized under environmentally normal and industrially realistic conditions. And it can be repolymerized without too much trouble ensuring the permanent cycle of circular materials.

These polymers can be recycled and reused infinitely, Chen said. This would make the recycling of plastic economically viable and stop giving news about plastic islands in the middle of the Pacific. However, the new material will now be tested outside the laboratory. We must continue learning to achieve a world in which plastics are not a double-edged sword.

Patent ES2286385 from New Ice (Nov. 1, 2002) refers to biodegradable or compostable containers. The process for forming the biodegradable material comprises: (a) forming a pregelled starch suspension, “pregel”, produced from about 2-15% potato starch by weight of the pregel, and about 75-95% by weight water in weight of the pregel in such a way that the pre-gelled suspension is maintained at temperatures between 0-60° C.; (b) mixing together wood fibers or wood flour having an aspect ratio between about 1:2 and 1:8, a suspension of pregelled starch produced from about 15% corn starch by weight of the pregel and about 85% water by weight of the pregel, and a native starch to form a homogeneous mixture; (c) adding the homogenous mixture to the pre-gelled starch suspension to form a final homogeneous mouldable composition; and (d) molding the homogeneous moldable composition with heat to form a biodegradable material. This document uses the gelled form of starch as the base of the polymer, contrary to the biopolymer form of the present application.

The patent U.S. Pat. No. 6,406,530B1 (Jun. 18, 2002) discloses a thermoplastic mixture of biopolymer based on starch and an effective amount of lignin and sufficient water to generate the plasticization and produce biodegradable articles. In this document, the formulation uses a mixture of starches and water. From the starches, also called lignins, after several lysis carried out followed by a cooking process, a biodegradable gel is obtained which can be formed as a film that could be a thermoplastic mixture. However, unlike the formula of the invention, the resistance of starch plus water is weak.

The patent CN1281864 in favor of Kim Yong-Bok (Jan. 31, 2001) reveals a procedure to manufacture plastic substitute products through the use of natural materials. Agricultural by-products and wood derivatives are used such as rice husks, stems of rice plants, stems of corn plants, stems of grain plants, stems of wheat plants, saw dust and the like. The washed and dried sludge produced from the alcoholic factory is crushed to a particular size. Then, the crushed particles are mixed with natural adhesives (such as corn starch, potato starch and the like) and coated with rosin or natural resins, and then molding is carried out by applying a pressure on a molding machine, whereupon the substitute articles of plastic are manufactured. Raw materials are readily available from rural areas, and the molding is carried out at a temperature of 100-300° C. The method basically uses starches to obtain a gel to make the plastic substitute. This formulation is also based on starch, unlike the invention that does not contain starches as a support raw material.

The patent ES2198469 of DAICEL CORP. (Jun. 22, 1996) discloses a biodegradable thermoplastic polyester resin composition consisting of 1 to 200 parts by weight of a polycaprolactone and 100 parts by weight of an aliphatic polyester resin that is not a polycaprolactone. said aliphatic polyester resin contains urethane linkages and can be obtained from dicarboxylic acid, or an ester thereof, or an anhydride thereof, or a diol, and in that said urethane linkages are obtained from aliphatic polyisocyanate constituting between 0.1 to 5 parts by weight per-100 parts by weight of polyester resin. The biodegradable items consist of disposable cups for drinks and meals, knives, spoons, disposable forks, etc.

This document indicates that the term “biodegradability” means that it has a degradation ratio greater than 20%, preferably greater than 60% after immersion for 28 days in an active sludge obtained from a municipal drain regulated according to JIS K6950. It also notes that the temperatures for molding the biodegradable polyether resin composition are between 140 and 220° C., preferably between 180 and 200° C., conditions which in the present invention are not required

Starch, although it is true is a natural polymer, when it comes into contact with a drink, it begins to disintegrate, that is why in the formula of the present invention, it is not looking to create a gel but rather a dough resistant to instantaneous disintegration as would be the case with starch gel. It is for this reason that the state of the art uses polymers such as caprolactones, polyethylene resins, modified wheat starch, corn straw fiber, epoxidized soybean oil, lignins, etc., in order to give hardness to the materials disposable gelled, but that do not show resistance especially to contact with hot liquids.

With all this information, it is evident that, in the state of the art, the problem of biodegradable polymers that can be molded in containers with depth and that these can resist to the hydration and disintegration of the biodegradable container due to the contact of biodegradable polymers has not been solved. cold or very hot liquids. Therefore, we can see that there is still a need to provide biopolymers for the industry of disposable materials that withstand the conditions of hardness, strength, elasticity and, above all, that have an accelerated biodegradation.

An object of the present invention is to provide a natural biopolymer type ceramic material of accelerated degradation, of great hardness, of high resistance to heat and humidity, even when the material comes in contact with liquids are very hot or cold, and that a at the same time be friendly to human health and to the environment, as is achieved with the biopolymeric ceramic material of the present invention.

### FIELD OF INVENTION

The present invention relates to a biodegradable poly-ceramic from biodegradable formulations for the manufacture of disposable containers of accelerated degradation, which have high resistance to liquids, heat and temperature.

### DETAILED DESCRIPTION OF THE INVENTION

The present invention provides a biodegradable poly-ceramic material having high hardness, high resistance to fractionation or rupture of the disposable product, high resistance to heat and humidity and with an accelerated degree of biodegradation. The biodegradable poly-ceramic material is a product formed by the agglutination of the semi-digested carbohydrates with the suitable solvent, which provides greater resistance, hardness, elasticity and tension to the biodegradable poly-ceramic material, essential characteristics for the manufacture of the disposable biodegradable utensils of the present invention.

The method to prepare the plastic substitute basically focuses on using natural materials of food grade, that is, they are safe and safe ingredients and suitable to contain any type of food or even serve as a nutrient base to receive a plant or seed and, for this reason, they are very safe since they contribute to the care of the environment. The desiccated biodegradable poly-ceramic material provides safety and comfort to the user when using utensils made from the biopolymer even when they contain very hot liquids.

The term “flour” should be understood as the product obtained by grinding cereals and other seeds, for example: wheat, rye, spelled, oats, corn, barley, rice, quinoa, beans, chickpeas, lentils, linens, chestnuts, almonds, amaranth, yucca, potatoes, achira, etc. You also get flour from tubers such as cassava, potatoes, achira, etc. The purpose of working with flours is to benefit from the binding and plasticizing properties of the raw material since, together with the other components of the invention, it makes it possible to obtain the biodegradable poly-ceramic material of the present invention.

The term “starch” should be understood as the product obtained by grinding corn starches and/or cereals which, when in contact with water and subjecting them to heat, tend to form gels. Examples of starches which are used in the present invention are starch of corn, wheat, rye, barley, sorghum, millet, etc.

The term “plasticizer” should be understood as the natural additive that is added to the formulation in order to increase the volume and soften the biopolymer mixture. Synergistic example of plasticizers that are used in the present invention are glycosides and/or glycerin which give the biodegradable poly-ceramic material elasticity effects. The term “preservative” should be understood as a natural substance added in order to avoid contamination of the biodegradable poly-ceramic material during the process of preparation of the mixture. Examples of preservatives used in the present invention are citric acid, vinegar and salt.

The term “gelling agent” should be understood as substances with the ability to create gels. A gel is composed of two phases (solid-liquid) that give it a higher density than liquids; however, its structure resembles that of a solid. Examples of gelling agents that are used in the present invention are collagen, agar-agar, alginate, unflavored gelatin, fishtail, etc.

The term “stabilizer” should be understood as the products that help to form bonds or bridges for the formation of more complex structures and are defined as the substances that prevent the change of shape or chemical nature of the products to which they are incorporated. , maintaining the physical-chemical balance of the components. Examples of stabilizers which are used in the present invention are cellulose derivatives such as for example carboxymethylcellulose (CMC), carboxyethyl cellulose (CEC) and/or pectin and/or guar gum and/or tragacanth and/or xanthan.

The term “waterproofing” should be understood to mean substances that, when added to the biodegradable poly-ceramic material, provide hydrophobic qualities to the utensils made with the poly-ceramic mixture, providing a certain resistance to humidity to disposable biodegradable utensils up to a certain period of time. time, while facilitating the molding during the process of setting up the utensils. Examples of waterproofing materials used in the present invention are beeswax, carnauba wax and anhydrous lanolin.

The term “coloring” must be understood as the additive that colors food products naturally, provides a uniform appearance to the poly-ceramic material, since natural colors are used, increasing its visual appeal and/or maintaining the organoleptic qualities related to color in those foods in which the processed can modify them. Natural dyes are preparations obtained from food and other natural materials obtained through a physical or chemical extraction or a hydroalcoholic extraction that results in a selection of pigments. Examples of dyes used in the present invention are chlorophyll extract, coffee extract, nuts, etc.

The term “flavoring” should be understood as the essential oil of natural extracts, flavorings derived from spices, juice or fruit or vegetable juices. Examples of flavors that are used in the present invention are those from fruits and vegetables such as anthocyanins, caramel, carotenes, betalains, turmeric, chlorophyll, spices, fruit extract or fruit or vegetable juice.

The term “biodegradable poly-ceramic material” should be understood as the product obtained by cold-mixing the components of the invention which, after subjecting the mixture of flours and binders with some organic diluent, is heated to fortify and structure the material of the invention.

The term “hardness” should be understood as the phenomenon of resistance to fractionation or rupture of the utensils made with the poly-ceramic material, very similar to that of a plastic container.

The term “tension” must be understood as the phenomenon of the biodegradable poly-ceramic material that opposes the laminar rupture of the biopolymer at the moment of stretching in the molding process, whether this is cold or hot stretching.

The term “gel” should be understood as the product obtained by cold mixing and boiling to produce gelation of the starch used. Among the substances capable of forming gels we have, for example: starch, gelatin and agar. The gelatine obtained from animal by-products only forms gels at low temperatures so, if it is desired that the gel is maintained at room temperature, or even higher, other substances must be resorted to to stabilize its constitution. Starch acts very well as a thickener under normal conditions, but has a tendency to lose liquid over time or when the food is frozen or thawed. The composition of the invention makes it possible to produce a stable gel that assists in the plasticity of the poly-ceramic material of the invention.

The term “biodegradable disposable” should be understood as the products obtained by mixing the components of the invention which have characteristics of great hardness, high resistance to fractionation or rupture of the disposable product, high resistance to heat and humidity, and an accelerated degree of biodegradation. These utensils, after being used, can be discarded or used as any organic matter of waste or nutrient for plants or seeds. Even, they can be digested as food in the form of a cookie.

The term “thermo-plastic” should be understood as the product with flexibility and malleability properties obtained by mixing the components of the invention when subjected to heat molding so that it can be manufactured in the desired form.

It is necessary to understand the term “thermo-resistant” to the phenomenon that the biodegradable utensil made with the biodegradable poly-ceramic material has to keep unchanged when receiving any type of food (it even supports very hot liquids), heat and touch insulator, keeps its structure unaltered, no hydration or disintegration occurs in normal daily use. Also, the phenomenon of thermal and physical stability of the utensils is checked when they come into contact with hot liquids and utensils are not deformed, they have high resistance even when the utensils are used as containers for the heating of food by means of microwave, supporting times between 30 seconds to 1.30 minutes.

The term “non-transferable” should be understood to the poly-ceramic material that maintains the integrity of its walls and does not transfer any type of residue from or through the wall of the utensils and keeps the food that contains them unalterable.

The term “biodegradable” should be understood as the product that can be broken down into natural nutrients due to the action of environmental elements and biological organisms.

The term “accelerated degradation” should be understood as the phenomenon of disintegration and decomposition of the biodegradable poly-ceramic material of the present invention, which has a great advantage measured in times of disintegration and degradation in a period of less than 30 days, preferably less than 20 days.

The term “elasticity” should be understood to the physical phenomenon that the biodegradable poly-ceramic material presents when it is subjected to the molding of the utensils either hot or cold, providing management facilities and malleability of the biopolymeric mass of accelerated degradation.

The term “thermo-rigid” should be understood as the phenomenon of hardness and resistance of the biodegradable poly-ceramic material when it is subjected to the drying, molding and compression process used to produce the biodegradable materials prepared with the biodegradable poly-ceramic material.

The term “dehydration and incrustation” should be understood as the interstitial water extraction phenomenon of the plant material with the intracellular biopolymer transfer process. This process allows the plant materials to receive the biodegradable poly-ceramic material to the plant cells while the intracellular water leaves the hydroalcoholic medium, producing the preservation of the fresh vegetal materials since they maintain their natural structure and resistance to deterioration. These preserved plant materials may optionally be part of the disposable utensils of the present invention.

In the present invention, the materials used are basically flours, this because their contribution in the formulation of the invention provides consistency, hardness, strength and elasticity to the biopolymer, allowing to develop several configuration alternatives to the disposable materials.

The ingredients of the formula of the invention are all of food grade and can be consumed if desired, since, in the process of making the dough, it proceeds to cook and dehydrate the material until achieving consistency, hardness, flexibility and elasticity of the poly-ceramic material.

The materials used are ingredients for mass consumption, such as flours for human consumption and the other components are gelling, thickeners, stabilizers and natural preservatives used for pastry and bakery.

With the formula of the invention, a plasticizer is created that at the time of drying and baking, becomes waterproof, since natural waterproofing agents (such as beeswax) are used. This allows the formula not only serve for sorbets but for other types of containers that resist liquids.

In the formulation, a natural coloring of food grade can be added without any problem, and this could be consumed, since the base of the formula is flours in suitable proportions and that are also used for bread making, that is to say it is completely natural, and especially biodegradable.

Although it is true in the formulas of the state of the art a gelled mass is obtained, the elements they use do not give the characteristic of resistance to hot liquids, hardness and flexibility as that of the poly-ceramic material of the invention, the degradation is not accelerated and the cost of production is very high.

In the process of preparation of the poly-ceramic material, the flours are pulverized, sieved through a fine sieve and mixed dry to obtain a homogeneous fine powder mixture. With this mixture of flours and the mixture of organic diluents subjected to heat, what is sought is that the fibers and proteins are compacted and that at the same time, with the mixture of natural gelling agents achieve the characteristics of flexibility, malleability, elasticity, hardness and resistance of the poly-ceramic material of the present invention.

In the method of the invention, a starch, gelling and stabilizing solution is prepared. This suspension will act as a rubber and texturizer that will bind the fibers of the 1 or more flours used in the formulation. This formulation with the contribution of the wax provides a certain degree of impermeability to the poly-ceramic material and, therefore, to the disposable utensils of the present invention.

The masses coming from the mixtures of flours can be mixed in a mixing equipment with organic diluents; the mass obtained is maintained in prolonged kneading at room temperature, this in order that said mass achieves homogeneity, flexibility and stability.

After the kneading period, the biopolymer mass can be left to stand for the necessary time (for example, for a period of 1 hour) for the dough to release the air bubbles produced in the kneading period. In case the mass is pelletized, the granules of the biodegradable poly-ceramic material feed the hopper of the manufacturing equipment of the disposable materials of the present invention.

### Process Summarized

The biodegradable poly-ceramic material is prepared by a procedure that includes the following steps:

1. Mix one or more flours, the one or more starches and the one or more dry stabilizers; Mix the one or more preservatives with one or more solvents and water until a clear-looking suspension is obtained;

2. Mix the one or more gelling agents with water and heat until a semi-dense gelled mass is obtained;

3. Mix the one or more waterproofers with one or more solvents and heat until a homogeneous mixture is obtained;

4. Mix the compositions obtained from steps 1 to 4 until obtaining a semi-soft dough.

5. Mix everything to form a homogeneous mass. Optionally, one or more colorants and/or flavorings may be added. Optionally the obtained mass is subjected to molded and prefabricated disposable utensils of accelerated biodegradation. Alternatively, in another embodiment of the preparation process of the poly-ceramic, said mass is subjected to a pelletization process to obtain the granules of the biopolymer.

When the poly-ceramic utensil contains a hot liquid, it is achieved that the biopolymer does not hydrate or dissolve immediately; in general, the material is stable to liquid, whether hot or cold, even when the biopolymer material is in contact with it, especially it resists very hot liquids, for example, it resists the heat is a freshly brewed coffee with which the user has comfort in its use.

Optionally, another object of the present invention is the incorporation of immortalized plant materials into the disposable materials of the present invention. With this embodiment, the disposable materials have many design alternatives without losing the accelerated degradation character of the biopolymer of the invention. The plant materials used can be leaves of achira, banana, corn, chicory, spinach, lettuce, arugula, flowers, roses, etc.

### Process in Detail

To preserve the plant materials, the process is done as follows:

1. Primary dehydration of fresh plant material, subjected to hydroalcoholic bath between 65-75% at temperature between 20 to 45° C./15-45 minutes;
2. Secondary dehydration of fresh plant material, subjected to a hydroalcoholic bath between 75-85% at a temperature between 20 to 45° C./15-45 minutes;
3. Tertiary dehydration in combination with a primary encrustation in a hydroalcoholic bath of between 85 to 95% and biopolymer solution between 1 to 5% (w/w) at a temperature between 20 to 45° C./15-45 minutes;
4. Quaternary dehydration in combination with a secondary encrustation in a hydroalcoholic bath of between 85 to 95% and biopolymer solution between 1 to 5% (w/w) at a temperature between 20 to 45° C./15-45 minutes;
5. Mounting of preserved plant material in disposable utensils made with accelerated degradation biopolymer; Y.
6. Dry biodegradable disposable utensils in an oven or stove at a temperature between 20 to 30° C./15-30 minutes.

### EXAMPLE 1

The biodegradable poly-ceramic material of the invention comprises

| Component | Examples | Percentage (p/p) |
|---|---|---|
| One or more | Wheat, Rye, Spelled, Oats, Corn,, | 40.00-60.00 |
| flours | Barley, Rice, Quinoa, Beans, | |
| | Chickpea, Lentil, Lino, Chestnuts, | |
| | Almonds, Amaranth, Yucca, | |
| | Potatoes, Achira. | |
| One or more | Corn, Wheat, Rye, Barley, Sorghum, | 0.50-5.00 |
| starches | Millet. | |
| One or more | Collagen, agar-agar, alginate, | 0.10-2.00 |
| gelling agents | unflavored gelatine, fish tail. | |
| One or more | Pectin, CMC, guar gum, and/or | 5.00-40.00 |
| stabilizers | tragacanth and/or xanthan | |
| One or more | Beeswax and/or wax carnauba and/or | 0.10-1.50 |
| waterproofing | lanolin anhydrous | |
| One or more | Glycerin and/or vinegar and/or | 3.00-25.00 |
| solvents | ethyl alcohol or their mixtures | |
| One or more | Citric acid, vinegar and/or salt or | 1.00-3.00 |
| preservatives | its mixture | |
| One or more | Natural and/or mineral salts | 0.05-0.50 |
| colorants and/ | | |
| or flavorings | | |
| Water | c.s.p. | c.s.p. |

### EXAMPLE 2

Preserved plant materials

Vegetal material

| Solvent | Percentage (p/p) | Temperature (° C.) |
|---|---|---|
| Dehydration 1 | 65 a 75 | 20-45 |
| Dehydration 2 | 75 a 85 | 20-45 |
| Dehydration 3 + incrustation 1 | 85 a 95 + 1 a 5% | 20-45 |
| Dehydration 4 + incrustation 2 | 85 a 90 + 1 a 5% | 20-45 |

### EXAMPLE 3

Accelerated degradation of biodegradable disposable polycarboxy materials (FIGS. 3 to 6)

Biodegradation of poly-ceramic utensils

| | Dias de exposición | | | |
|---|---|---|---|---|
| % de Degradación | Day 1 | Day 9 | Day 13 | Day 15 |
| Double thickness plate | 0 | 65 | 85 | 99 |
| Double thickness vessel | 0 | 70 | 87 | 99 |
| Double thickness straw | 0 | 75 | 90 | 99 |

The accelerated degradation test shows that biodegradable utensils degrade at high speed. Poly-ceramic material has degraded by 99% on the fifteenth day compared with the samples on the first day. This accelerated degradation effect will allow the accelerated reduction of disposable polluting containers that overwhelm the current world and that damage the environment, for this reason it is an inescapable solution for the replacement of the typical disposable containers of the state of the art. As an additional point, the poly-ceramic containers of the invention contribute with nutritive elements to fertilize the fields.

### EXAMPLE 4

For the test of no transfer or transfer of elements or structural residues from the walls of the container, we proceed to fill the vessels separately with hot liquid and cold liquid, let it act for 30 minutes and proceed to discard the contents of the vessels. Immediately, we proceed to verify the internal surface of the vessels to check the integrity of their walls. The result is presented in the following table:

Waste visualization

| Liquid | Vessel 1 | Vessel 2 | Observations |
|---|---|---|---|
| Hot coffee | No | No | There is no detachment |
| Cold water | No | No | There is no detachment |

This test demonstrates the physical-chemical stability of the poly-ceramic material with which the biodegradable utensils are manufactured, since they remain unchanged when receiving liquid beverages. In this way, the quality, safety and efficacy of biodegradable utensils is ensured.

The present invention is detailing within the following claims:

1. Biodegradable poly-ceramic material and disposable materials of accelerated degradation CHARACTERIZED BY a mixture of:
a) One and/or more natural flours in a percentage between 40 to 60% (w/w);
b) One or more natural starches in a percentage between 0.50 to 5% (w/w);
c) One or more natural gelling agents in a percentage between 0.10 to 2.00% (w/w);
d) One or more natural stabilizers between a percentage of 0.50 to 40.00% (w/w);
e) One or more waxy natural waterproofing in proportions between 0.10 to 30% (w/w);
f) One or more natural solvents in a percentage between 3.00 to 25.00% (w/w);
g) One or more preservatives in a percentage between 1.00 to 3.00% (w/w); Y
h) Optionally one or more colorants and/or mineral salts and/or natural flavorings in a percentage between 0.05 to 0.5% (w/w).

2. Biodegradable poly-ceramic material and disposable materials of accelerated degradation according to claim 1 CHARACTERIZED BY optionally it also contains preserved plant material fixed in the utensils.

3. Biodegradable poly-ceramic material and disposable materials of accelerated degradation according to any of the previous claims CHARACTERIZED BY it presents a period of disintegration and degradation between 15 to 20 days.

4. Biodegradable poly-ceramic material and accelerated degradation disposable materials according to any of the preceding claims CHARACTERIZED BY the one or more natural flours is selected from wheat, rye, spelled, oats, corn, barley, rice, quinoa, beans, chickpea, lentils, linens, chestnuts, almonds, amaranth, yucca, potatoes, garlic, or their mixtures in proportions between 35 and 55% (w/w), or between 30 to 50% (w/w), or between 25 to 45% (w/w), or between 20 to 40% (w/w), or between 15 to 35% (w/w) or between 10 to 30% (w/w).

5. Biodegradable poly-ceramic material and accelerated degradation disposable materials according to any of the preceding claims CHARACTERIZED BY the one or more natural starches is selected from corn, wheat, rye, barley, sorghum, millet or their mixtures, in proportions between 0.45 to 4.50% (p/p); or between 0.25 to 4.00% (w/w).

6. Biodegradable poly-ceramic material and accelerated degradation disposable materials according to any of the preceding claims CHARACTERIZED BY the one or more natural gelling agents is selected from collagen, agar-agar, alginate, unflavored gelatin, fishtail or their mixtures in proportions between 0.05 to 1.5% (w/w).

7. Biodegradable poly-ceramic material and accelerated degradation disposable materials according to any of the preceding claims CHARACTERIZED BY the one or more natural stabilizers is selected among cellulosic additives such as CMC and/or Pectin and/or guar gum and/or tragacanth and/or xanthan in proportions between 0.025 to 45% (w/w) and the agar-agar is between 0.1 to 1.5% (w/w) or 0.05 to 1% (w/w).

8. Biodegradable poly-ceramic material and accelerated degradation disposable materials according to any of the preceding claims CHARACTERIZED BY the one or more waxy natural waterproofing agents is selected from beeswax and/or carnauba wax and/or anhydrous lanolin in proportions between 0, 05 to 25% (w/w) or in proportions between 0.025 to 20% (w/w).

9. Biodegradable poly-ceramic material and accelerated degradation disposable materials according to any of the previous claims CHARACTERIZED BY the one or more natural solvents is selected from glycerin and/or vinegar and/or ethyl alcohol or their mixtures in proportions between 2.50 and 20.50% (p/p), or between 2.00 to 20.00% (p/p), or between 1.50 to 15.00% (p/p), or between 1.00 to 10.00% (p/p), or between 0.50 to 5.00% (p/p).

10. Biodegradable poly-ceramic material and accelerated degradation disposable materials according to any of the preceding claims CHARACTERIZED BY which the one or more natural preservatives is selected from citric acid, vinegar and/or salt or their mixtures in proportions between 0.05 to 4.50% (p/p), or between 0.025 to 4.00% (p/p), or between 0.015 to 3.50% (p/p).

11. Biodegradable poly-ceramic material and accelerated degradation disposable materials according to any of the previous claims CHARACTERIZED BY the poly-ceramic material and disposable utensils have physical-chemical stability when they come into contact with hot or cold liquids, high hardness, high resistance to heat and temperature, flexibility to the molding process and degradation in an accelerated manner. 12. Method of preservation of natural vegetable materials CHARACTERIZED By the fresh natural plant material is subjected to a first dehydration in a hydroalcoholic solution of 65 to 75%; followed by a second dehydration in a hydroalcoholic solution of 75 to 80%; followed by a third dehydration in a mixture by the first encrustation in a hydroalcoholic solution of 80 to 85% and a biopolymer solution of 1 to 5% (w/w); followed by a second encrustation in a hydroalcoholic solution of 85 to 90% together with the polymeric material diluted of 0.5 to 5%, at temperatures between 20 to 45° C., where each stage should take a time of 15 to 45 minutes.

13. Method of preservation of plant materials according to claim 13 CHARACTERIZED BY the disposable biodegradable material optionally mounted with the embedded natural plant material is dried in oven or stove at temperatures between 20 to 45° C./15-30 minutes.
